(19) United States
(12) Patent Application Publication
(10) Pub. No.: US 2025/0363499 A1
(43) Pub. Date: Nov. 27, 2025

(54) SYSTEM FOR COMPLIANCE ANALYSIS

(71) Applicant: Wells Fargo Bank, N.A., San Francisco, CA (US)

(72) Inventors: Michael Paul Bortis, Tustin, CA (US); Ausrin Lee Grelle, Riverside, IL (US); Guangcao Ji, Plano, TX (US); Carleton Jay Lindgren, JR., Denver, CO (US); Manesh Saini, New York, NY (US); Winthrop Treynor Smith, Littleton, CO (US)

(21) Appl. No.: 18/670,155

(22) Filed: May 21, 2024

(51) Int. Cl. G06Q 30/018

(52) U.S. Cl. CPC G06Q 30/018

(57) ABSTRACT

Various systems and methods for analyzing business compliance are described herein. An electronic online system is configured to receive, from a user of the electronic online system, an indication of a law for analysis; parse the law to produce law chunks; receive, from the user, an indication of a business policy for analysis; parse the business policy to produce policy chunks; compare the law chunks with the policy chunks to determine similarity scores for respective pairs of law chunks and policy chunks; and present law chunks that have similarity scores less than a threshold similarity score to the user.

### BACKGROUND

The area of corporate compliance, also referred to as legal compliance, includes the laws and regulations that an organization is required to follow. An organization may develop rules and policies for its employees, business partners, external vendors, or other business associates. These rules or polices are drafted to ensure that the company is compliant with the applicable laws and regulations. As a business grows, the compliance requirements may change. When new laws are added or existing laws are modified, the business compliance requirements need to change accordingly. Legal compliance becomes increasingly complex for large companies that operate across different jurisdictions or include a multitude of subsidiaries.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating an operating environment, according to an embodiment;

FIG. 2 is a flow diagram illustrating data and control flow for compliance analysis, according to an embodiment;

FIG. 3 is a block diagram illustrating a machine learning module, according to an embodiment;

FIG. 4 is a flowchart illustrating a method for analyzing business compliance, according to an embodiment; and

FIG. 5 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Systems and methods described herein provide corporate compliance analysis. The compliance analysis system is configured to find the gaps in a company's coverage of laws and regulations that are applicable to it. This system is useful for all large and mid-sized entities that have compliance risks, regardless of industry. Laws can be unduly lengthy. It is difficult to identify all of the sections of all of the laws that may be applicable to a company. It is also very tedious and costly to determine whether these sections are covered by any of the numerous existing policies.

For ease of discussion, the term law is used herein and meant to include laws, acts, regulations, codes, or rules that are passed by a legislative authority or published and adopted by an executive agency. Laws are generally binding rules that are established by a governing authority (e.g., a state or federal legislature or agency). Laws define acceptable conduct, establish rights and liberties of citizens, establish mechanisms for resolution of legal disputes, or protect the health, safety, and welfare of the public.

The term policy as used herein is to refer to a set of guidelines, rules, procedures, or principles established by an organization to govern its operations and decision-making processes. These policies are formulated to ensure consistency, efficiency, legality, and ethical conduct within the organization. Example policies include those that relate to human resources, financial conduct, operations, customer relations, use of information technology, and ethical behavior.

The system first ingests the laws of interest and finds the sections that are applicable to the company. It then compares these sections to the company's policies and determines whether the company is compliant with the sections. The sections of laws that are not covered are considered gaps. By identifying these gaps, the system can efficiently reveal potential compliance risks. In addition, the system is able to compare policies across different business units to identify redundant, contrary, or inconsistent policies and provide recommendations or notifications to a user of these issues.

This system uses various large language model (LLM) tools to compare documents and identify the areas where the company is missing coverage. The laws and policies are first transformed into data that can be handled by the models. LLM agents are used to find the sections within the law that are applicable to the company. These sections of law are then compared with those of the policies using a similarity analysis. Sections that do not have similar chunks in policies are candidates for gaps. These functions and others are described in more detail below.

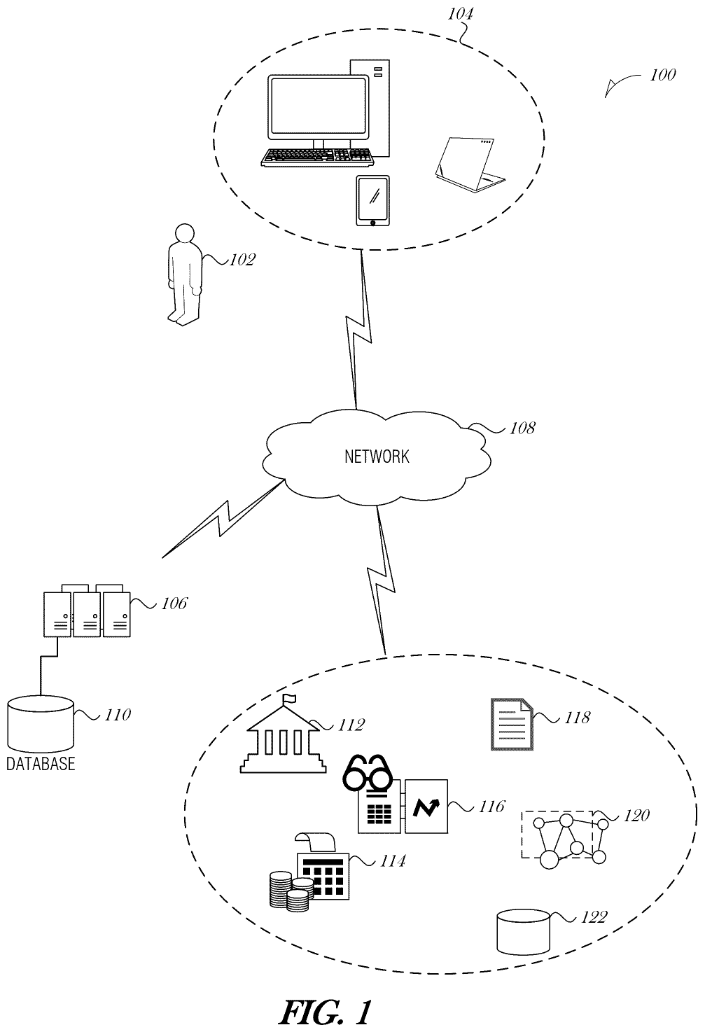

FIG. 1 is a diagram illustrating an operating environment 100, according to an embodiment. A user 102 may use a user device 104 to access an online system 106 for compliance analysis. The user device 104 may be of any type of form factor including, but not limited to a desktop computer, a mobile device, a laptop computer, a smartphone, a tablet device, a personal digital assistant, or the like.

The online system 106 may include various web servers, database servers, proxy devices, firewalls, storage devices, and network devices. The online system 106 may provide a web-based interface accessible via a uniform resource locator (URL). The online system 106 may provide various levels of security, such as requiring an account with a username and password, a secure channel (e.g., HTTPS), two-factor authentication, and the like.

To connect to the online system 106, the user 102 may execute an application (“app”) to connect via a network 108. In various examples, the servers and components in the operating environment 100 may communicate via one or more networks such as network 108. The network 108 may include one or more of local-area networks (LAN), wide-area networks (WAN), wireless networks (e.g., 802.11 or cellular network), the Public Switched Telephone Network (PSTN) network, ad hoc networks, cellular, personal area or peer-to-peer networks (e.g., Bluetooth®, Wi-Fi Direct), or other combinations or permutations of network protocols and network types. The network 108 may include a single local area network (LAN) or wide-area network (WAN), or combinations of LANs or WANs, such as the Internet.

Data used in the online system 106 may be organized and stored in a variety of manners. For convenience, the organized collection of data is described herein as database 110. The specific storage layout and model used in the database 110 may take a number of forms and the database 110 may utilize multiple models. Database 110 may be, but is not limited to, a relational database (e.g., SQL), non-relational database (NoSQL) a flat file database, object model, document details model, or a file system hierarchy. The database 108 may store data on one or more storage devices (e.g., a hard disk, random access memory (RAM), etc.). The storage devices may be in standalone arrays, part of one or more servers, and may be located in one or more geographic areas.

A database management system (DBMS) may be used to access the data stored within the database 110. The DBMS may offer options to search the database 110 using a query and then return data in the database 110 that meets the criteria in the query. For example, a SQL query may be utilized to retrieve all laws related to a subject matter area or policies related to a business unit. The DBMS may operate on one or more of the components of the online system 106.

The online system 106 provides a compliance analysis platform. One function provided by the online system 106 is to ingest laws for later comparison to policies. Another function provided by the online system 106 is to compare laws with policies to determine coverage gaps. Another function provided by the online system 106 is to compare policies with one another to determine similarities and differences.

In operation, a user 102 may log into the online system 106 to access the database 110. The user 102 is able to access laws, determine whether laws are applicable to their organization or business unit, analyze the laws in comparison to their policies to determine coverage gaps, and perform other comprehensive compliance analysis.

The online system 106 may be connected to one or more other external systems, which may include a government legislation system 112 (e.g., the U.S. House of Representatives, the Minnesota State House of Representatives, etc.), a government agency system 114 (e.g., the U.S. Environmental Protection Agency, the U.S. Department of Agriculture, the Minnesota Department of Agriculture, etc.), a private legal research service 118 (e.g., Westlaw, FindLaw, LexisNexis, LexisOne, etc.), a social media system 120 (e.g., Facebook, X, online legal blogs, etc.), and other sources 122 (e.g., case law reporters, journals, news outlets, etc.). While some external systems are illustrated in FIG. 1, it is understood that the online system 106 may be connected to any of a variety of online systems to access laws, regulations, policies, or the like.

By interfacing with one or more of these systems 112-122, the online system 106 is able to gather information about laws that may be applicable to one or more business units of an organization. Using this information, the online system 106 is able to determine similarities and differences between the laws and internal policies of the organization. After identifying these distinctions, the online system 106 may notify the user 102, provide recommended actions, or perform other operations as discussed herein.

The online system 106 may be included with one or more servers in one or more data centers in a cloud computing infrastructure. Various services may be provided by the cloud computing infrastructure including an interface to a large language model (LLM) model, such as ChatGPT by OpenAI, Bard By Google®, PaLM 2 by Google®, LLAMA2 ((Large Language Model Meta AI), Zephyr, Mistral, or other generative artificial intelligence (AI) systems and corresponding LLM tools.

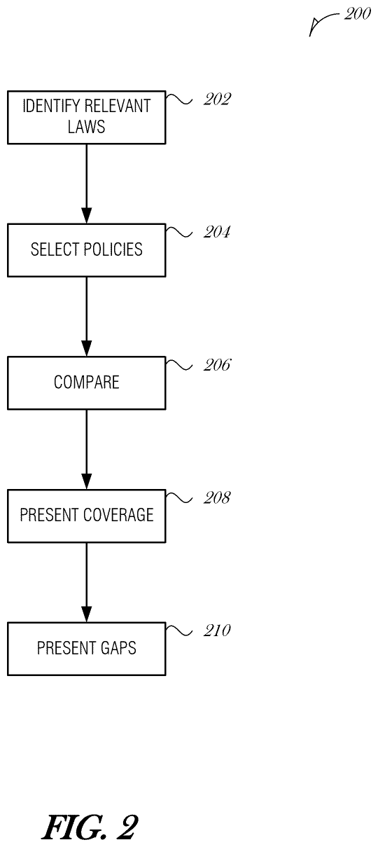

FIG. 2 is a flow diagram illustrating data and control flow 200 for compliance analysis, according to an embodiment. At stage 202, one or more data sources of laws are accessed to determine those that are relevant to the organization. The relevant laws are filtered out and saved. The data sources may be internal to the organization or external to the organization.

In an example implementation, a user interface (UI) is presented to the user. A UI element, such as a dropdown list, a text input control, or a tree control, may be used to select or provide an indication of a law. For instance, the law may be stored in one or more files accessible over a network. The law may be identified with a file directory and filename, selected by the user based on a file selection user interface dialog box. As another example, the law may be identified with a uniform resource locator (URL), which indicates a location of an electronic copy of the law. The URL may be from a legislative body, an agency, a legal compendium, a search engine, or the like. As another example, the law may be identified using a dropdown list of laws that are available to analyze in a database, where the dropdown is programmatically populated with a description of the laws and their associated database unique identifier to reference one or more records of the laws in the database. In any case, the text of the law is retrieved for analysis.

Each relevant law is chunked. Content chunking is a process to separate content into smaller segments, which are easy for AI to process. In an example, the law is chunked based on hierarchy using semantic chunking. Laws and regulatory codes are often organized by title, division, part, chapter, article, and section. As an example, a law may be divided by section within a title (e.g., Title II, Section 202 as one chunk and Title II, Section 203 as another chunk). In a further example, the law may be chunked down to sub-sections (e.g., Title II, Section 202(a)(1)(i) as one chunk and Title II, Section 202(a)(1)(ii) as another chunk, or Title II, Section 202(a)(1) (with subsections (i-xi)) as one chunk and Title II, Section 202(a)(2) (with subsections (i-iv)) as another chunk). The granularity of the chunks may be based on the design and limitations of the system. In an example, chunk size or chunk resolution may be provided as input by a user. Chunk size may be adjusted based on the number of total tokens a model is capable of processing (e.g., context window, 4096 tokens for GPT-3.5 models, 8192 tokens in GPT-4-8k models, and 32,768 tokens for GPT-4-32k) and how much context or granular semantic information is needed.

Various chunking algorithms may be used, such as naïve splitting (e.g., using an arbitrary delimiter, such as newline or period, to chunk into sentence structures), Natural Language Toolkit (NLTK) (another sentence-level tokenizer), spaCy (another sentence-level tokenizer with context preservation), recursive chunking (e.g., using a hierarchical and iterative process), Markdown (e.g., using a markup language to indicate headings, lists, code blocks, sections, etc., to chunk content), LaTex chunking (e.g., using LaTex commands and environments to create chunks), etc.

Law chunks may be filtered based on whether they are relevant to the organization. The filtering may be performed by providing the law chunks to an LLM with a prompt to determine whether the law chunk is relevant to the organization, a business line of the organization, a product line of the organization, a business area of the organization, a market area of the organization, or the like. Optionally, the law chunks may be manually filtered by a person in the organization. By filtering law chunks, the user is able to reduce the number of tokens that will be used in the context window, thereby possibly allowing more granular chunks to be used in the model.

At stage 204, one or more policies are selected for analysis against the laws. The policies may be selected based on their entirety, for example, all of the Human Resource policies, or by a chapter, section, rule, or other grouping. Policies are chunked in a manner similar to that of laws (e.g., by chapter, section, subsection, rule, or the like). Policy chunks may be configured by a user to control the size, resolution, or other aspects of the policy to be compared.

The policies may be provided in the same UI as the law selection, or in a separate UI. Similar to the law selection, a UI element, such as a dropdown list, a text input control, or a tree control, may be used to select or provide an indication of a policy. For instance, the policy may be stored in one or more files, and identified with a file directory and filename, selected by the user based on a file selection user interface dialog box. As another example, the policy may be identified with a uniform resource locator (URL), which indicates a location of an electronic copy of the policy. The URL may reference an internal data source, such as an intranet, human resources webpage, or the like. As another example, the policy may be identified using a dropdown list of policies that are available to analyze in a database, where the dropdown is programmatically populated with a description of the policies and their associated database unique identifier to reference one or more records of the policies in the database. In any case, the text of the policy is retrieved for analysis.

At stage 206, the one or more policies are compared to the one or more laws that are relevant to the organization. Each law chunk is vectorized using a text-to-vector operation, such as Word2Vec, text-embedding-ada-002 by OpenAI, SentenceTransformers and SBERT for Python derived from BERT (Bidirectional Encoder Representations from Transformers) by Google, or another technique to create text embeddings. Similarly, the policy chunks are vectorized. The resulting vectors are stored in a vector database (or vector store), which enables fast matching between embeddings. Example vector database include, but are not limited to PineCode, Weaviate, and the like.

Embeddings are vectors (or arrays of numbers) that represent the contextual meaning of the tokens. A token may be a word, group of words, sentence, or paragraph, depending on how the chunking was performed. Embeddings are derived from the parameters or the weights of the AI model. The embeddings are used to encode and decode the input and output texts. Embeddings can help the AI model to understand the semantic and syntactic relationships between the tokens, and to generate more relevant and coherent texts. Embeddings are an important component of the transformer architecture that GPT-based models use.

To compare the one or more laws to the one or more policies, a prompt (e.g., query) is used to compare embeddings of a law chunk with embeddings of a policy chunk. The prompt may be submitted to a vector database to initiate the vector comparisons. This is performed for each law chunk. An application programming interface (API) may be used to streamline the process of chunk comparison. The API may also be used to batch process comparisons. The law chunks and policy chunks may have unique identifiers for easier reference. In an example, the policies and laws are compared using a vector comparison operation, such as a dot product, cosine similarity, soft cosine similarity, Euclidean distance, or the like. The comparison produces a similarity score of a given law chunk and policy chunk. In the end, each law chunk has a similarity score for each policy chunk. Relationships that fall below a threshold may be ignored as being directly contrary, irrelevant, opposite, or unrelated.

At stage 208, law chunks and policy chunks that are similar enough, in view of a similarity score threshold, are presented in a user interface. The presentation may be configured to present a top-10 listing, a top-5 listing, or other type of filtered listing of ranked comparisons. Alternatively, the presentation may provide a full listing of every comparison that was calculated and their corresponding similarity scores.

At stage 210, gaps in legal coverage are identified by identifying law chunks that do not have any statistically relevant policy chunks mapped to them. There may be a threshold similarity score used to determine whether a law chunk is unrelated to a policy chunk. These gaps in coverage may also be output to a user in the user interface. Optionally, the gaps in coverage may be provided to a compliance officer as a report, a notification, an alert, an email, or the like. Compliance officers include but are not limited to attorneys, administrators, executive directors, or the like.

It is understood that the analysis may be reversed so that a process starts with the policy chunks of one or more policies and determines their relevance to one or more laws. In this case, at the end of the process, each policy chunk will have a similarity score for each law chunk. Relationships that fall below a threshold may be ignored as being irrelevant or unrelated.

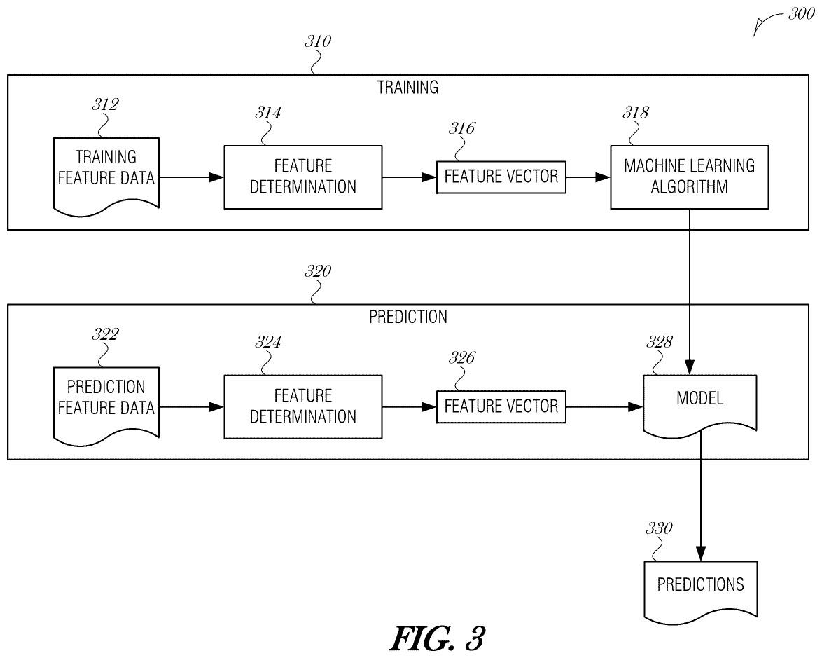

FIG. 3 is a block diagram illustrating a machine learning module 300, according to an embodiment. The machine learning module 300 may be implemented in whole or in part by one or more computing devices. In some examples, a training module 310 portion of the machine learning module 300 may be implemented by a different device than a prediction module 320 portion. In these examples, a model 328 may be created on a first machine and then sent to a second machine. In various examples, the machine learning module 300 may be used generally for evaluating, generating, or augmenting coaching output.

Machine learning module 300 utilizes a training module 310 and a prediction module 320. Training module 310 inputs training feature data 312 into feature determination module 314. The training feature data 312 may include data determined to be predictive of rationalizing, characterizing, optimizing, categorizing, or summarizing laws or policies. Categories of training feature data may include policy data, laws, rules, news articles, social media data, other third-party data, or the like. Training feature data 312 and prediction feature data 322 may include, for example one or more of: laws, regulations, policies, and the like.

Feature determination module 314 selects training vector 316 from the training feature data 312. The selected data may fill training vector 316 and comprise a set of the training feature data that is determined to be predictive. In some examples, the tasks performed by the feature determination module 314 may be performed by the machine learning algorithm 318 as part of the learning process. Feature determination module 314 may remove one or more features that are not predictive to train the model 328. This may produce a more accurate model that may converge faster. Information chosen for inclusion in the training vector 316 may be all the training feature data 312 or in some examples, may be a subset of the training feature data 312.

In other examples, the feature determination module 314 may perform one or more data standardization, cleanup, or other tasks such as encoding non numerical features. For example, for categorical feature data, the feature determination module 314 may convert these features to numbers. In some examples, encodings such as “One Hot Encoding” may be used to convert the categorical feature data to numbers. This enables a representation of the categorical variables as binary vectors and provided a “probability-like” number for each label value to give the model more expressive power. One hot encoding represents a category as a vector whereby each possible category value is represented by one element in the vector. When the data is equal to that category value, the value of the vector is a ‘1’ and all other elements are zero (or vice versa).

The training vector 316 may be utilized (along with any applicable labels) by the machine learning algorithm 318 to produce a model 328. In some examples, other data structures other than vectors may be used. The machine learning algorithm 318 may use one or more layers to develop a model 328. Example layers may include convolutional layers, dropout layers, pooling/up sampling layers, SoftMax layers, and the like. Example models may be a neural network, where each layer is comprised of a plurality of neurons that take a plurality of inputs, weight the inputs, and input the weighted inputs into an activation function to produce an output which may then be sent to another layer. Example activation functions may include a Rectified Linear Unit (ReLu), and the like. Layers of the model may be fully or partially connected. In other examples, machine learning algorithm may be a gradient boosted tree and the model may be one or more data structures that describe the resultant nodes, leaves, edges, and the like of the tree.

In the prediction module 320, prediction feature data 322 may be input to the feature determination module 324. The prediction feature data 322 may include the data described above for the training feature data, but for specific items such as developing coaching outputs personalized to a user. In some examples, the prediction module 320 may be run sequentially for one or more items. Feature determination module 324 may operate the same, or differently than feature determination module 314. In some examples, feature determination modules 314 and 324 are the same modules or different instances of the same module. Feature determination module 324 produces vector 326, which is input into the model 328 to produce predictions 330. For example, the weightings and/or network structure learned by the training module 310 may be executed on the vector 326 by applying vector 326 to a first layer of the model 328 to produce inputs to a second layer of the model 328, and so on until the prediction 330 is output. As previously noted, other data structures may be used other than a vector (e.g., a matrix).

The training module 310 may operate in an offline manner to train the model 328. The prediction module 320, however, may be designed to operate in an online manner. It should be noted that the model 328 may be periodically updated via additional training or user feedback. For example, additional training feature data 312 may be collected. The feedback, along with the prediction feature data 322 corresponding to that feedback, may be used to refine the model 328 by the training module 310.

In some example embodiments, results obtained by the model 328 during operation (e.g., outputs produced by the model in response to inputs) are used to improve the training data, which is then used to generate a newer version of the model 328. Thus, a feedback loop is formed to use the results obtained by the model to improve the model 328.

The machine learning algorithm 318 may be selected from among many different potential supervised or unsupervised machine learning algorithms. Examples of learning algorithms include artificial neural networks, convolutional neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, gradient boosted tree, linear classifiers, quadratic classifiers, k-nearest neighbor, linear regression, logistic regression, a region based CNN, a full CNN (for semantic segmentation), a mask R-CNN algorithm for instance segmentation, and hidden Markov models. Examples of unsupervised learning algorithms include expectation-maximization algorithms, vector quantization, and information bottleneck method.

The model 328 may be stored in a storage device. In some examples in which the training operations and predictions are performed on separate computing devices, the model 328 may be transmitted to a computing device to perform predictions. In various examples, the model 328 may be used for evaluating, generating, or augmenting output (e.g., suggesting policy language to cover a gap in legal coverage).

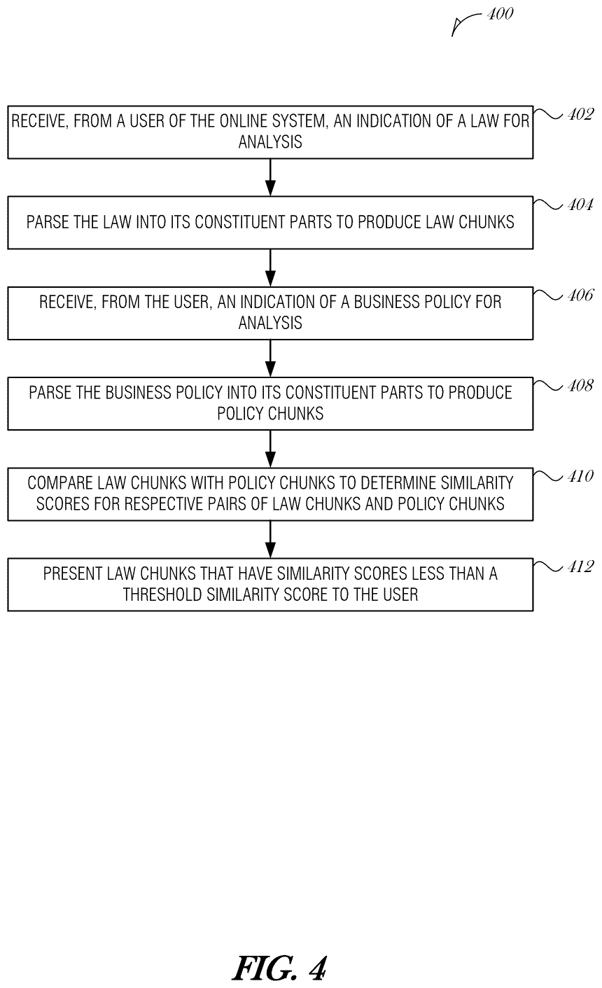

FIG. 4 is a flowchart illustrating a method 400 for analyzing business compliance, according to an embodiment. The method 400 may be performed by an electronic system (e.g., online system 106) or any of the modules, logic, circuits, processors, or components described herein.

At 402, an indication of a law for analysis is received from a user of the online system. In an embodiment, the indication of the law includes a filename of a document that includes the law. In another embodiment, the indication of the law includes a universal resource locator (URL) of a document that includes the law. In another embodiment, the indication of the law includes a database identifier of a record that includes the law.

At 404, the law is parsed to produce law chunks. In an embodiment, parsing the law to produce law chunks includes applying a chunking algorithm to the law. In various embodiments, the chunking algorithm includes at least one of: naïve splitting, a sentence-level tokenizer process, a sentence-level tokenizer process with context preservation, recursive chunking, or semantic chunking.

At 406 an indication of a business policy for analysis is received from the user. In an embodiment, the indication of the business policy includes a filename of a document that includes the business policy. In another embodiment, the indication of the business policy a universal resource locator (URL) of a document that includes the business policy. In another embodiment, the indication of the business policy includes a database identifier of a record that includes the business policy.

At 408 the business policy is parsed to produce policy chunks. In an embodiment, parsing the business policy to produce policy chunks includes applying a chunking algorithm to the business policy. In various embodiments, the chunking algorithm includes at least one of: naïve splitting, a sentence-level tokenizer process, a sentence-level tokenizer process with context preservation, recursive chunking, or semantic chunking.

At 410, the law chunks are compared with the policy chunks to determine similarity scores for respective pairs of law chunks and policy chunks. In an embodiment, comparing the law chunks with the policy chunks to determine similarities includes calculating a vector representation of a law chunk, calculating a vector representation of a policy chunk, and using a vector comparison operation to compare the vector representation of the law chunk to the vector representation of the policy chunk, the vector comparison producing a similarity score. In a further embodiment, the vector comparison is one of: a dot product operation, a cosine similarity operation, or a soft cosine similarity operation.

At 412, law chunks that have similarity scores less than a threshold similarity score are presented to the user. The range for similarity scores is based on the type of vector comparison used. For instance, for cosine similarity, the range of similarity scores is in the closed interval [−1,1]. A value of 1 means an angle of 0 (vectors are as similar as possible). A value of 0 means that the vectors are orthogonal and a value of-1 means that the vectors are pointing in opposite directions. To determine where there are gaps between laws and policies, a closed range of [−0.2, 0.2] may be used, for example, to capture vectors that are unrelated but not directly opposite from one another. The threshold similarity score may be 0.2 in this example. The threshold similarity score may represent an upper or lower boundary. Several threshold similarity scores may be used to define an interval of interest. The number of law chunks that have similarity scores less than the threshold may be limited in the output user interface. For example, a limit of ten may be used to show the top ten law chunks that have a similarity score of less than 0.2, with respect to a particular policy chunk. Other arrangements are possible with different similarity operations.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

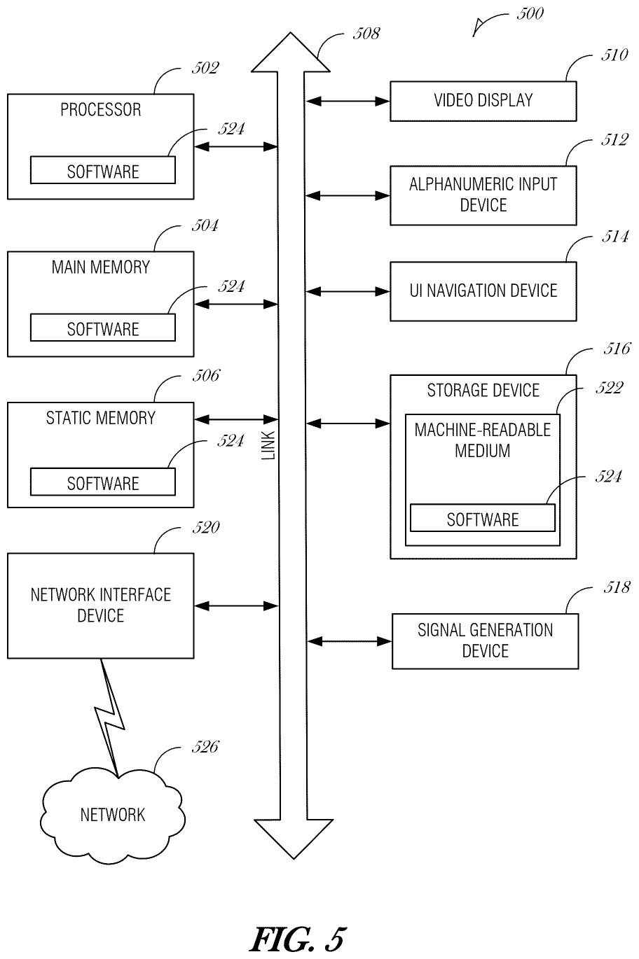

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, set-top box, wearable device, personal computer (PC), a tablet PC, a hybrid tablet, a personal digital assistant (PDA), a mobile telephone, cloud server, web server, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computer system 500, with the main memory 504, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### ADDITIONAL NOTES & EXAMPLES

Example 1 is an electronic online system for compliance analysis, the online system comprising: a processor subsystem; and memory including instructions, which when executed by the processor subsystem, cause the processor subsystem to: receive, from a user of the electronic online system, an indication of a law for analysis; parse the law to produce law chunks; receive, from the user, an indication of a business policy for analysis; parse the business policy to produce policy chunks; compare the law chunks with the policy chunks to determine similarity scores for respective pairs of law chunks and policy chunks; and present law chunks that have similarity scores less than a threshold similarity score to the user.

In Example 2, the subject matter of Example 1 includes, wherein the indication of the law includes a filename of a document that includes the law.

In Example 3, the subject matter of Examples 1-2 includes, wherein the indication of the law includes a universal resource locator (URL) of a document that includes the law.

In Example 4, the subject matter of Examples 1-3 includes, wherein the indication of the law includes a database identifier of a record that includes the law.

In Example 5, the subject matter of Examples 1-4 includes, wherein to parse the law to produce law chunks, the processor subsystem is to apply a chunking algorithm to the law.

In Example 6, the subject matter of Example 5 includes, wherein the chunking algorithm includes at least one of: naïve splitting, a sentence-level tokenizer process, a sentence-level tokenizer process with context preservation, recursive chunking, or semantic chunking.

In Example 7, the subject matter of Examples 1-6 includes, wherein the indication of the business policy includes a filename of a document that includes the business policy.

In Example 8, the subject matter of Examples 1-7 includes, wherein the indication of the business policy a universal resource locator (URL) of a document that includes the business policy.

In Example 9, the subject matter of Examples 1-8 includes, wherein the indication of the business policy includes a database identifier of a record that includes the business policy.

In Example 10, the subject matter of Examples 1-9 includes, wherein to parse the business policy to produce policy chunks, the processor subsystem is to apply a chunking algorithm to the business policy.

In Example 11, the subject matter of Example 10 includes, wherein the chunking algorithm includes at least one of: naïve splitting, a sentence-level tokenizer process, a sentence-level tokenizer process with context preservation, recursive chunking, or semantic chunking.

In Example 12, the subject matter of Examples 1-11 includes, wherein to compare the law chunks with the policy chunks to determine similarities, the processor subsystem is to: calculate a vector representation of a law chunk; calculate a vector representation of a policy chunk; use a vector comparison operation to compare the vector representation of the law chunk to the vector representation of the policy chunk, the vector comparison producing a similarity score.

In Example 13, the subject matter of Example 12 includes, wherein the vector comparison is one of: a dot product operation, a cosine similarity operation, or a soft cosine similarity operation.

Example 14 is a method for compliance analysis, the method performed on an electronic online system, the method comprising: receiving, from a user of the electronic online system, an indication of a law for analysis; parsing the law to produce law chunks; receiving, from the user, an indication of a business policy for analysis; parsing the business policy to produce policy chunks; comparing the law chunks with the policy chunks to determine similarity scores for respective pairs of law chunks and policy chunks; and presenting law chunks that have similarity scores less than a threshold similarity score to the user.

In Example 15, the subject matter of Example 14 includes, wherein the indication of the law includes a filename of a document that includes the law.

In Example 16, the subject matter of Examples 14-15 includes, wherein the indication of the law includes a universal resource locator (URL) of a document that includes the law.

In Example 17, the subject matter of Examples 14-16 includes, wherein the indication of the law includes a database identifier of a record that includes the law.

In Example 18, the subject matter of Examples 14-17 includes, wherein parsing the law to produce law chunks comprises applying a chunking algorithm to the law.

In Example 19, the subject matter of Example 18 includes, wherein the chunking algorithm includes at least one of: naïve splitting, a sentence-level tokenizer process, a sentence-level tokenizer process with context preservation, recursive chunking, or semantic chunking.

In Example 20, the subject matter of Examples 14-19 includes, wherein the indication of the business policy includes a filename of a document that includes the business policy.

In Example 21, the subject matter of Examples 14-20 includes, wherein the indication of the business policy a universal resource locator (URL) of a document that includes the business policy.

In Example 22, the subject matter of Examples 14-21 includes, wherein the indication of the business policy includes a database identifier of a record that includes the business policy.

In Example 23, the subject matter of Examples 14-22 includes, wherein parsing the business policy to produce policy chunks comprises applying a chunking algorithm to the business policy.

In Example 24, the subject matter of Example 23 includes, wherein the chunking algorithm includes at least one of: naïve splitting, a sentence-level tokenizer process, a sentence-level tokenizer process with context preservation, recursive chunking, or semantic chunking.

In Example 25, the subject matter of Examples 14-24 includes, wherein comparing the law chunks with the policy chunks to determine similarities comprises: calculating a vector representation of a law chunk; calculating a vector representation of a policy chunk; using a vector comparison operation to compare the vector representation of the law chunk to the vector representation of the policy chunk, the vector comparison producing a similarity score.

In Example 26, the subject matter of Example 25 includes, wherein the vector comparison is one of: a dot product operation, a cosine similarity operation, or a soft cosine similarity operation.

Example 27 is a non-transitory machine-readable medium comprising instructions for compliance analysis, which when executed by a machine in an electronic online system cause the machine to: receive, from a user of the electronic online system, an indication of a law for analysis; parse the law to produce law chunks; receive, from the user, an indication of a business policy for analysis; parse the business policy to produce policy chunks; compare the law chunks with the policy chunks to determine similarity scores for respective pairs of law chunks and policy chunks; and present law chunks that have similarity scores less than a threshold similarity score to the user.

In Example 28, the subject matter of Example 27 includes, wherein the indication of the law includes a filename of a document that includes the law.

In Example 29, the subject matter of Examples 27-28 includes, wherein the indication of the law includes a universal resource locator (URL) of a document that includes the law.

In Example 30, the subject matter of Examples 27-29 includes, wherein the indication of the law includes a database identifier of a record that includes the law.

In Example 31, the subject matter of Examples 27-30 includes, wherein to parse the law to produce law chunks, the instructions cause the machine to apply a chunking algorithm to the law.

In Example 32, the subject matter of Example 31 includes, wherein the chunking algorithm includes at least one of: naïve splitting, a sentence-level tokenizer process, a sentence-level tokenizer process with context preservation, recursive chunking, or semantic chunking.

In Example 33, the subject matter of Examples 27-32 includes, wherein the indication of the business policy includes a filename of a document that includes the business policy.

In Example 34, the subject matter of Examples 27-33 includes, wherein the indication of the business policy a universal resource locator (URL) of a document that includes the business policy.

In Example 35, the subject matter of Examples 27-34 includes, wherein the indication of the business policy includes a database identifier of a record that includes the business policy.

In Example 36, the subject matter of Examples 27-35 includes, wherein to parse the business policy to produce policy chunks, the instructions cause the machine to apply a chunking algorithm to the business policy.

In Example 37, the subject matter of Example 36 includes, wherein the chunking algorithm includes at least one of: naïve splitting, a sentence-level tokenizer process, a sentence-level tokenizer process with context preservation, recursive chunking, or semantic chunking.

In Example 38, the subject matter of Examples 27-37 includes, wherein to compare the law chunks with the policy chunks to determine similarities, the instructions cause the machine to: calculate a vector representation of a law chunk; calculate a vector representation of a policy chunk; use a vector comparison operation to compare the vector representation of the law chunk to the vector representation of the policy chunk, the vector comparison producing a similarity score.

In Example 39, the subject matter of Example 38 includes, wherein the vector comparison is one of: a dot product operation, a cosine similarity operation, or a soft cosine similarity operation.

Example 40 is at least one machine-readable medium including instructions that, when executed by processing circuitry, cause the processing circuitry to perform operations to implement of any of Examples 1-39.

Example 41 is an apparatus comprising means to implement of any of Examples 1-39.

Example 42 is a system to implement of any of Examples 1-39.

Example 43 is a method to implement of any of Examples 1-39.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. An electronic online system for compliance analysis, the online system comprising:
a processor subsystem; and
memory including instructions, which when executed by the processor subsystem, cause the processor subsystem to:
receive, from a user of the electronic online system, an indication of a law for analysis;
parse the law to produce law chunks;
receive, from the user, an indication of a business policy for analysis;
parse the business policy to produce policy chunks;
compare the law chunks with the policy chunks to determine similarity scores for respective pairs of law chunks and policy chunks; and
present law chunks that have similarity scores less than a threshold similarity score to the user.

2. The electronic online system of claim 1, wherein the indication of the law includes a filename of a document that includes the law.

3. The electronic online system of claim 1, wherein the indication of the law includes a universal resource locator (URL) of a document that includes the law.

4. The electronic online system of claim 1, wherein the indication of the law includes a database identifier of a record that includes the law.

5. The electronic online system of claim 1, wherein parse the law to produce law chunks, the processor subsystem is to apply a chunking algorithm to the law.

6. The electronic online system of claim 5, wherein the chunking algorithm includes at least one of: naïve splitting, a sentence-level tokenizer process, a sentence-level tokenizer process with context preservation, recursive chunking, or semantic chunking.

7. The electronic online system of claim 1, wherein the indication of the business policy includes a filename of a document that includes the business policy.

8. The electronic online system of claim 1, wherein the indication of the business policy a universal resource locator (URL) of a document that includes the business policy.

9. The electronic online system of claim 1, wherein the indication of the business policy includes a database identifier of a record that includes the business policy.

10. The electronic online system of claim 1, wherein to parse the business policy to produce policy chunks, the processor subsystem is to apply a chunking algorithm to the business policy.

11. The electronic online system of claim 10, wherein the chunking algorithm includes at least one of: naïve splitting, a sentence-level tokenizer process, a sentence-level tokenizer process with context preservation, recursive chunking, or semantic chunking.

12. The electronic online system of claim 1, wherein to compare the law chunks with the policy chunks to determine similarities, the processor subsystem is to:
calculate a vector representation of a law chunk;
calculate a vector representation of a policy chunk;
use a vector comparison operation to compare the vector representation of the law chunk to the vector representation of the policy chunk, the vector comparison producing a similarity score.

13. The electronic online system of claim 12, wherein the vector comparison is one of: a dot product operation, a cosine similarity operation, or a soft cosine similarity operation.

14. A method for compliance analysis, the method performed on an electronic online system, the method comprising:
receiving, from a user of the electronic online system, an indication of a law for analysis;
parsing the law to produce law chunks;
receiving, from the user, an indication of a business policy for analysis;
parsing the business policy to produce policy chunks;
comparing the law chunks with the policy chunks to determine similarity scores for respective pairs of law chunks and policy chunks; and
presenting law chunks that have similarity scores less than a threshold similarity score to the user.

15. The method of claim 14, wherein the indication of the law includes a filename of a document that includes the law, a universal resource locator (URL) of a document that includes the law, or a database identifier of a record that includes the law.

16. The method of claim 14, wherein parse the law to produce law chunks, the processor subsystem is to apply a chunking algorithm to the law, wherein the chunking algorithm includes at least one of: naïve splitting, a sentence-level tokenizer process, a sentence-level tokenizer process with context preservation, recursive chunking, or semantic chunking.

17. The method of claim 14, wherein the indication of the business policy includes a filename of a document that includes the business policy, a universal resource locator (URL) of a document that includes the business policy, or a database identifier of a record that includes the business policy.

18. The method of claim 14, wherein to parse the business policy to produce policy chunks, the processor subsystem is to apply a chunking algorithm to the business policy, wherein the chunking algorithm includes at least one of: naïve splitting, a sentence-level tokenizer process, a sentence-level tokenizer process with context preservation, recursive chunking, or semantic chunking.

19. A non-transitory machine-readable medium comprising instructions for compliance analysis, which when executed by a machine in an electronic online system cause the machine to:
receive, from a user of the electronic online system, an indication of a law for analysis;
parse the law to produce law chunks;
receive, from the user, an indication of a business policy for analysis;
parse the business policy to produce policy chunks;
compare the law chunks with the policy chunks to determine similarity scores for respective pairs of law chunks and policy chunks; and
present law chunks that have similarity scores less than a threshold similarity score to the user.

20. The non-transitory machine-readable medium of claim 19, wherein to compare the law chunks with the policy chunks to determine similarities, the processor subsystem is to:
calculate a vector representation of a law chunk;
calculate a vector representation of a policy chunk;
use a vector comparison operation to compare the vector representation of the law chunk to the vector representation of the policy chunk, the vector comparison producing a similarity score.
